(19) United States
(12) Patent Application Publication
(10) Pub. No.: US 2022/0013029 A1
(43) Pub. Date: Jan. 13, 2022

(54) AUGMENTED VIDEO INTERACTION LEARNING ANALYSIS PLATFORM

(71) Applicant: eLearning IP, LLC, Orlando, FL (US)

(72) Inventors: Brittany Suzanne Liberty, Orlando, FL (US); Michael A. Liberty, Orlando, FL (US)

(21) Appl. No.: 17/369,649

(22) Filed: Jul. 7, 2021

Related U.S. Application Data
(60) Provisional application No. 63/048,928, filed on Jul. 7, 2020.

(51) Int. Cl. G09B 7/04

(52) U.S. Cl. CPC G09B 7/04

(57) ABSTRACT

A system dynamically providing personalized learning experiences to students via a digital learning platform. During a learning session, in which a teaching entity teaches a lesson having one or more learning objectives, a set of visual and acoustic observations of a student and a set of visual and acoustic observations of the teaching entity are gathered. Based on the gathered observations, a set of student facts and a set of teaching facts are classified. The system then automatically maps at least one student fact(s) to at least one teaching fact(s) and instantiates a student profile to store the mapped student fact(s) and teaching fact(s). Based on the student profile, the system then determines a learning result for each of the one or more learning objectives. The system then automatically generates a template for a next learning session based on the student profile and the learning result.

### CROSS-REFERENCE TO RELATED APPLICATIONS

This application claims the benefit of and priority to U.S. Provisional Patent Application Ser. No. 63/048,928 filed on 7 Jul. 2020 and entitled “LEARNING ASSISTED BY AUGMENTED VIDEO INTERACTIONS ANALYSIS PLATFORM,” which application is expressly incorporated herein by reference in its entirety.

### BACKGROUND

Every student has a different learning style, and it is important for students to embrace their individuality and the unique way they learn. It would be helpful for teachers to understand what type of learner a student is because this information can be used to the student's advantage in class. Some colleges may have students fill in a form, containing information related to the students' learning styles and personalities to help the teachers know each student better and possibly provide each student with a better learning experience.

However, for younger students, e.g., pre-school or elementary school children, it is not possible for the students to accurately provide such information. Teachers or parents need to pay close attention to each student to find out each student's learning style over an extensive period. This may be burdensome to the teachers and/or the parents.

Additionally, the recent increase in school closures and transitions to virtual learning environments has significantly increased the difficulty of determining whether students are engaged in the material being presented and whether the teacher is meeting the students' needs. In many cases, the student-teacher relationship is limited to interactions through a video conference technology. These virtual interactions hide many social cues that a teacher may otherwise identify and react to. For example, a student on a virtual call may not be paying attention to the lesson, but the teacher may not have immediate access to a video feed of the student to make that determination. This separation between the student and teachers renders it very challenging to adapt to the individual needs to students.

Additionally, various fields of neuroscience seek to understand the structure and function of the brain and nervous system. Mindful awareness is an intentional non-judgmental awareness of the present moment and has been linked with multiple indicators of well-being. It would be ideal if a teacher or a parent can monitor each student and determine whether the student is mindful during a class. When the student's mind state is known, the teacher or the parent can then identify issues and help the student to foster mindfulness via practice.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

The embodiments described herein are related to providing a personalized learning experience to students via a digital learning platform. The digital learning platform is implemented by one or more computing systems (hereinafter also referred to as the “system” or “learning platform”), including (but not limited to) a server, a cloud storage, a mobile device, and/or any networked device(s). A learning session is a period of time, during which a teaching entity teaches a lesson to help students to achieve one or more learning objectives.

During the learning session, the system gathers a set of visual and acoustic observations of a student who is participating in the learning session. At the same time, the system also gathers a set of visual and acoustic observations of the teaching entity who is teaching in the learning session. Based on the set of visual and acoustic observations of the student, the system classifies a set of one or more student facts that are associated with the student, such as “like” or “dislike”. Based on the set of visual and acoustic observations of the teaching entity, the system classifies a set of one or more teaching facts that is associated with the teaching entity or teaching materials, such as various actions performed by the teaching entity (e.g., voice volumes, hand gestures, facial expressions, body movements, etc.) and/or various stimulus tasks presented to the student (e.g., music pieces, colors, figures, games, songs, etc.).

In some embodiments, the classifying of the student facts includes detecting real-time student interactions corresponding to a teaching fact. In some embodiments, the classifying of the set of student facts or classification of the set of teaching facts includes at least one of (1) digital image-based recognition, or (2) natural language processing, each of which may incorporate machine learning technologies.

The system then maps at least one student fact among the set of one or more student facts to at least one teaching fact among the set of one or more teaching facts, and instantiates a student profile (also referred to as a “first student profile”) to store the corresponding mapped at least one student fact(s) and at least one teaching fact(s). In some embodiments, the mapping of the at least one student fact(s) to the at least one teaching fact includes using logistic regression (which also incorporates machine learning technologies) to automatically determine one or more relationships between the mapped at least one student fact(s) and at least one teaching fact(s).

Based on the student profile, the system determines a learning result for each of the one or more learning objectives. In some embodiments, the learning session is a domain-specific knowledge-based learning session, which teaches one or more pieces of domain-specific knowledge to students. The one or more objectives for the domain-specific knowledge-based learning session is to have the students memorize or master the taught domain-specific knowledge consciously with mental effort. In such a case, some of the paired student fact(s) and teaching fact(s) in the student profile indicate whether the student has mastered a taught domain-specific knowledge. Based on these paired student fact(s) and teaching fact(s), the system may determine the learning result of each taught domain-specific knowledge.

Finally, based on the student profile and the learning result for each of the one or more learning objectives, the system then automatically generates a new template for a next learning session. The new template may include at least one of (1) one or more teaching actions to be performed by a teaching entity or (2) one or more stimulation tasks, each of which comprises at least one of a music piece, a color, a figure, a game, and/or a song.

In some embodiments, the system may also present the student profile to a user (e.g., the student, a parent, a teacher, a supervisor, and/or an expert) via a user portal. The user, reviewing the student profile, may then provide manual input(s) into the system. For example, an expert user may enter an input, manually mapping at least student fact among the set of student fact(s) to at least one teaching fact among the set of teaching fact(s). The generating of the template may be based on the automatically mapped at least one student fact(s) and teaching fact(s) and the manually mapped at least one student fact(s) and teaching fact(s).

The above-described process may repeat during the next learning session. For example, after the next learning session is completed, a second student profile is generated, and a second learning result for each of the one or more learning objectives is determined. The system can then automatically generate a next template for a next learning session based on the first student profile, the second student profile, and the second learning result(s).

This process may repeat again each time a learning session is performed. As such, many student profiles for the same student may be generated through many learning sessions having the same set of learning objectives and/or different sets of learning objectives. The system gradually learns the student's learning style each time a learning session is performed, and generates better digital learning templates for the student as time goes on.

Similarly, many students may be attending many different learning sessions. For each student, a separate student profile is generated during each learning session. Different students' profiles may also be aggregated and analyzed together to identify relevant student facts and teaching facts, such that the system can automatically generate a new template for a next learning session containing contents that fit multiple students' learning styles.

In some embodiments, the teaching entity may be a human being. Alternatively, the teaching entity may be an avatar. For example, the avatar may be automatically generated based on a human being teacher. In such a case, the template generated for the next learning session may also include (1) an avatar converting a real teaching entity into a virtual teaching entity, (2) a particular clothing outfit of the virtual teaching entity, (3) a particular voice of the virtual teaching entity, and/or (4) an accent of the virtual teaching entity.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not, therefore, to be considered to be limiting in scope, embodiments will be described and explained with additional specificity and details through the use of the accompanying drawings in which:

FIG. 1 illustrates an example environment, in which the principles described herein may be implemented;

FIG. 2 illustrates an example embodiment of a student terminal or a teacher terminal;

FIG. 3 illustrates an example embodiment of a digital learning platform that is configured to provide personalized learning experiences to students;

FIGS. 4A through 4E illustrate example data structures that may be used to store student facts, teaching facts, student profiles, learning results, and/or templates for learning sessions;

FIG. 5 illustrates a flowchart of an example method for providing a personalized learning experience to a student; and

FIG. 6 illustrates an example computing system in which the principles described herein may be employed.

### DETAILED DESCRIPTION

The embodiments described herein are related to providing personalized learning experiences to students via a digital learning platform. The digital learning platform is implemented by a computing system. The computing system may include, but is not limited to, a server, a cloud storage, a mobile device, and/or any networked device. During a learning session, a teaching entity teaches a lesson having one or more learning objectives.

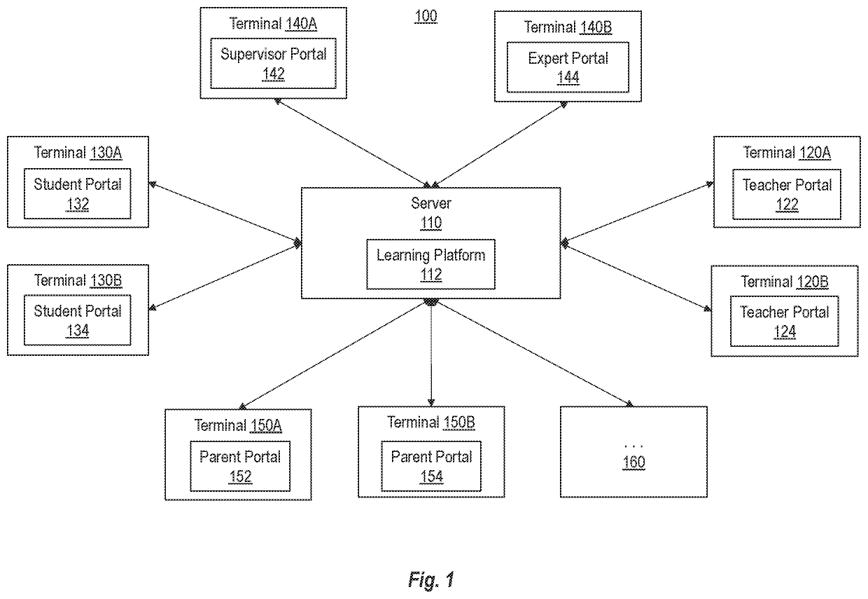

FIG. 1 illustrates an example environment 100, in which the principles described herein may be implemented. As illustrated in FIG. 1, a learning platform 112 is hosted on a server 110. Many different types of portals (including, but not limited to, student portals 132, 134, parent portals 152, 154, teacher portal 122, 124, supervisor portal 142, expert portal 144) are hosted at the server 110 via the learning platform 112. These different types of portals allow different types of users to use their own terminals 120A, 120B, 130A, 130B, 140A, 140B, 150A, 150B to communicate with the server 110 and to access the learning platform 112. Each type of portal is designed for a particular type of users, and may present a different user interface. The ellipsis 160 represents that there may be additional types or any number of portals configured to communicate with the server 110 and/or the learning platform 112.

Each terminal 120A, 120B, 130A, 130B, 140A, 140B, 150A, or 150B may be a computing system (e.g., a mobile device, a desktop computer, a laptop computer, a head-mounted device), or a browser or a specific software application that is running on a computing system. Each student, parent, teacher, supervisor, and/or expert may use his/her own terminal to login to his/her personal account of the learning platform 112 to access the corresponding portal. For example, a student may be able to use his/her own terminal 130A or 130B to login to a student account and to access the student portal 132 or 134. The student portal 132 or 134 may allow the student to register class(es) and attend the registered class(es). A parent may be able to use his/her own terminal 150A or 150B to login to a parent account to review his/her child's profiles and learning results and/or to provide additional input to the student profile(s) or lesson template(s) via the parent portal 152 or 154. A supervisor may be able to use the terminal 140A to review both the student data and teacher data via the supervisor portal 142. An expert may be able to use the terminal 140B to access student/teacher data and to provide expert opinions and/or modifications to student profile(s) or teaching template(s) for different students via the expert portal 144. A teacher may be able to use his/her own terminal 120A or 120B to teach classes and receive feedback from students, parents, supervisor(s), and/or expert(s).

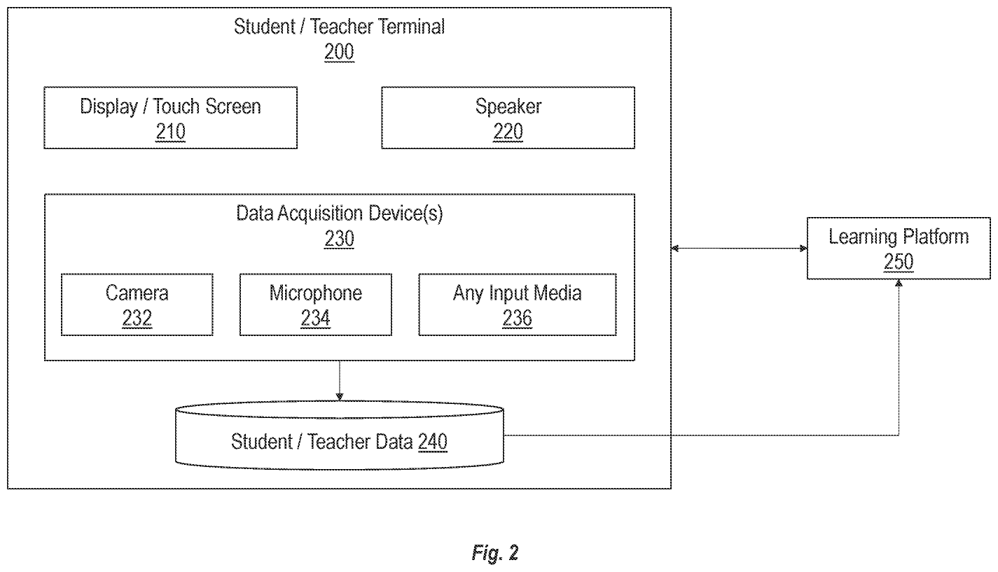

FIG. 2 illustrates an example student or teacher terminal 200, which corresponds to a student terminal 130A, 130B, or a teacher terminal 120A, 120B of FIG. 1. The student/teacher terminal 200 may include a display 210, a speaker 220, and one or more data acquisition device(s) 230. The one or more data acquisition device(s) 230 may include a camera 232, a microphone 234, and/or other additional input media 236 (e.g., a keyboard and/or a mouse). In some embodiments, the display 210 may be a touch screen, which may also be part of the data acquisition device(s) 230. In some embodiments, the student/teacher terminal 200 may be a head-mounted device (HMD). The data acquisition device(s) 230 of the HMD may further include one or more head tracking sensor(s), one or more gaze tracking sensor(s), and/or one or more hand sensor(s). When an HMD is used by a student or a teacher, the learning session may be presented in a virtual reality environment and/or an augmented reality environment.

The one or more data acquisition device(s) 230 are configured to gather student/teacher data 240, including visual and acoustic observations of a student or a teacher. The student/teacher data 240 includes visual and acoustic observations of a student or a teaching entity during a learning session. For example, the visual observations may include pictures or video taken of a teacher while the teacher explains concepts to the students. Similarly, the acoustic observations may include recording of the teacher's words, the teacher's tone, the speed at which the teacher speaks, and other similar audio observations. The student/teacher data 240 is sent to the learning platform 250, which corresponds to the learning platform 112 of FIG. 1. The learning platform 250 then processes the student/teacher data 240 to generate student profile(s) and learning objective scores, which can then be used by the learning platform 250 to generate content (e.g., template) for a next learning session.

In some embodiments, one or more students may be participating in a learning session in a classroom where a real teacher is teaching. In such an embodiment, the student terminal may physically only comprise a video camera that is viewing the student. Alternatively, or in addition, some of the students may be remotely taking the learning session, or the teacher may be teaching remotely. In some embodiments, all the students and the teacher are remote, and the learning session is an eLearning session, in which the communications between the students and teacher are performed via a computer network. Additionally, in some embodiments, the teacher may be an avatar, or a virtually rendered teacher that is computer controlled. The avatar may be wholly virtual or may comprise an overlay on a human teacher, such that the human teacher appears to be the avatar. As used herein, the words “teacher” and “teaching entity” are used interchangeably and refer to a human teacher or an avatar. In yet some other embodiments, some students may be wearing a head-mounted device, and the learning session occurs in a virtual environment.

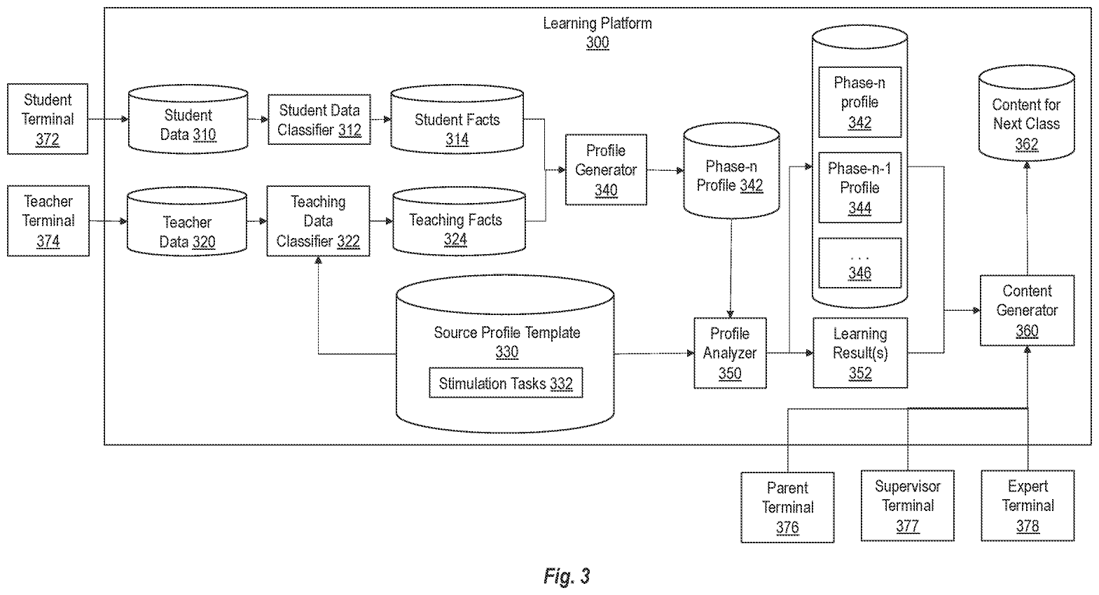

FIG. 3 illustrates an example embodiment of the learning platform 300. The learning platform 300 receives student data 310 (containing visual and acoustic observations of a student) from a student terminal 372, and receives teacher data 320 (containing visual and acoustic observations of a teacher) from the teacher terminal 374. The student terminal 372 corresponds to the student terminal 130A or 130B of FIG. 1 and/or 200 of FIG. 2, and the teacher terminal 374 corresponds to the terminal 120A or 120B of FIG. 1 and/or 200 of FIG. 2. The student data 310 is then fed into a student data classifier 312 to generate a set of one or more student facts 314, and the teacher data 320 is fed into a teaching data classifier 322 to generate a set of one or more teaching facts 324.

The student data classifier 312 may analyze the student data 310 in a variety of different ways. For example, the student data classifier 312 may comprise a classifier that classifies video images of the students based upon attentiveness, mood, engagement, and others similar metrics. The student facts 314 may include (but not limited to) the student's attitudes and tastes (e.g., like, dislike). For instance, during a history lesson, the student data classifier 312 may determine that the student is less attentive when the history lesson discusses historical politics and more attentive when the history lesson discusses historical architecture. Accordingly, the student data classifier 312 may generate a student fact 314 that the student is interested in historical architecture.

The teaching data classifier 322 may analyze the teacher data 312 in a variety of different ways. For example, the teaching data classifier 322 may comprise a classifier that classifies video images of the teacher based upon expression, speaking tone, and other similar metrics. The teaching facts 324 may include (but not limited to) voice volume, voice pitch, accent, body actions, hand gestures, and/or facial expressions. For instance, during the history lesson, the teaching data classifier 322 may determine that the student the teacher is more animated while teaching about historical literature and less animated when teaching about historical politics. Accordingly, the teaching data classifier 322 may generate a teaching fact 324 that the teacher is more engaging when teaching about historical literate.

In some embodiments, a source profile template 330 is also fed into the teaching data classifier 322. As explained briefly above, a profile template comprises a digital description of a lesson that is to be taught. As such, the source profile template 330 comprises a digital description of a particular lesson. The source profile template 330 may include different stimulation tasks 332 performed during the teaching session. As used herein, stimulation tasks 332 comprise lesson activities that are meant to stimulate students in the learning process.

As an example, the source profile template 330 may be based upon a lesson for teaching simple addition. The source profile template 330 may describe 1) an initial speaking portion where a teaching entity verbally explains addition to the students, 2) a second demonstration portion where the teaching entity performs an addition problem on a white board for the students to see, 3) a question and answer portion for students to inquire about what was taught, and 4) a stimulation task 332, in the form of a workbook page for the students to complete. The stimulation tasks 332 may also be classified by the teaching data classifier 322 to different teaching facts 324. Examples of other possible stimulations tasks 332 include music pieces, colors, figures, games, songs, etc.

In some embodiments, the student data classifier 312 and the teaching data classifier 322 may include at least one of (1) a digital image classifier configured to classify visual data or (2) a natural language processor configured to classify acoustic data. The digital image classifier may implement a machine learning network (e.g., deep neural network) to train the machine learning network to classify the student data 310 or teaching data 320 or 330.

In some embodiments, the student data classifier 312 may be a binary classifier that simply classifies each student fact into “like” or “dislike”, indicating whether the student likes or dislikes the content currently presented to the student. In some embodiments, the student data classifier 312 may be a multiclass classifier that classifies each student fact into multiple different attitudes, e.g., “mindful”, “absentminded”, “like”, “dislike”, etc. Similarly, in some embodiments, the teacher data classifier 322 may be a multiclass classifier that classifies each teacher fact into various teacher actions, e.g., hand gestures, voice volumes, facial expressions, etc. In some embodiments, when the student reacts to certain teacher actions, the student data classifier 312 and/or the teacher data classifier 322 detects such student reactions and teacher actions in substantially real time.

The student facts 314 and teaching facts 324 are then fed into a profile generator 340. The profile generator 340 maps at least one student fact 314 to at least one teaching fact 324. For example, a mapped pair of a student fact and a teaching fact may indicate that the student likes a particular song or game, and another mapped pair of a student fact and a teaching fact may indicate that the student dislikes a particular teacher action.

For example, the profile generator 340 may map that a first student reacted well when a teacher played a video to demonstrate a science principle. In contrast, the profile generator 340 may map that a second student reacted poorly to the video but reacted well to the teacher's verbal explanation of the scientific concept taught in the video. In response, the profile generator 340 may dynamically review the needs of each individual student in the class and determine how a particular concept should be taught. For instance, the profile generator 340 may generate a lesson profile that directs the teacher to introduce a video when teaching a subject that is challenging to the first student and direct the teacher to give verbal explanations of concepts that the second student find challenging. Further, the lesson profile may specifically identify which concepts the first and second student find challenging versus the ones they find easy.

In some embodiments, the profile generator 340 may implement logistic regression to automatically map the at least one student fact(s) to the at least one teaching fact(s). Logistic regression is a type of machine learning that analyzes data sets and identifies related variables. Here, the profile generator 340 may analyze the student facts 314 and teaching facts 324 to identify that certain teaching facts 324 may trigger certain student facts, e.g., causing the student to be mindful, or absentminded, and mapping the identified student facts 314 to the related teaching facts 324. Notably, in some cases, not every student fact may be mapped to a teaching fact. As long as there are sufficient pairs of student facts and teaching facts that are mapped to each other, the learning platform 300 can provide meaningful outcomes to users.

For instance, it may be identified that when the teaching entity wears a bright color a particular student is distracted by the color. In contrast, it may be found that the bright color is helpful and engaging to another student. As such, the profile generator 340 is able to intelligently generate a profile that describes the individual students needs and attributes, the teachers' attributes and behaviors, and the lesson characteristics.

At the end of the learning session, the profile generator 340 instantiates a student profile 342 to store the mapped at least one student fact(s) and the at least one teaching fact(s). As used herein, the “student profile” comprises a student-specific data structure that comprises student facts unique to one or more students. As such, after each learning session, a new student profile is generated. When the student is brand new, the newly generated student profile 342 may be the first student profile ever generated for the student, which is also called a phase-1 profile. When there are already n−1 student profiles generated previously, the newly generated student profile 342 would be the nth student profile, which is also called phase-n profile.

The phase-n profile 342 is then fed into a profile analyzer 350, which may analyze the phase-n profile 342 to determine a learning result 352 of the one or more learning objectives. For example, for each of the one or more learning objectives, a percentage point score may be generated, indicating how well the student has achieved the corresponding learning objective. In some embodiments, the profile analyzer 350 also receives the source profile template 330 (containing the stimulation tasks 332 and the student's results with respect to the stimulation tasks 332). The source profile template 330 and the phase-n profile 342 may be analyzed together to determine the result(s) of the learning session.

In some embodiments, the learning session is a domain-specific knowledge-based learning session, which teaches one or more pieces of domain-specific knowledge to students. The one or more objectives for the domain-specific knowledge-based learning session is to have the students memorize or master the one or more pieces of domain-specific knowledge consciously with mental effort.

At least some of the stimulation tasks 332 may be designed to trigger a student interaction, which may, in turn, be used to determine whether a student has mastered a taught domain-specific knowledge. The student interaction may be classified by the student data classifier 312 into a student fact, and the stimulation task 332 may be classified by the teaching data classifier 322 into a teaching fact. The student fact is then mapped to the teaching fact by the profile generator 340. These mapped pairs of the student fact and the teaching fact are then used to determine whether the student has achieved a specific learning objective (e.g., remembered a particular domain-specific knowledge). For a same domain-specific knowledge, there may be multiple stimulation tasks 332 used to test whether the student has mastered it. Some of the student interactions may indicate that the student has mastered it, and some of the student interactions may indicate that the student has not mastered it. The multiple student interactions may then be aggregated to generate a score (e.g., a percentage point), indicating how well the student has mastered the knowledge.

Then student profiles 342, 344, 346 and the learning results 352 are then input into a content generator 360 to automatically generate content 362 (e.g., a source profile template) for a next learning session or class. The automatically generated content 362 may include one or more teacher actions to be performed by a teaching entity (e.g., voice volumes, hand gestures, facial expressions, body movements, etc.) and/or one or more stimulus tasks (e.g., music pieces, colors, figures, games, songs, etc.).

The content generator 360 may also receive user input(s) from one or more parents' terminal(s) 376 (corresponding to the terminal 150A or 150B of FIG. 1), supervisor terminal(s) 377 (corresponding to the terminal 140A of FIG. 1), and/or expert terminal 378 (corresponding to the terminal 140B of FIG. 1). These user inputs may also be taken into account in addition to the automatically generated student profiles 342, 344, and 346 and learning result(s) 352 by the content generator 360, when generating the content 362 for the next learning session or class. For example, a parent may provide information through a parent terminal 376 that indicates that the parent believes their child needs help with a multiplication skills or the parent may enter information indicating that a particular teaching style or stimulation task causes undue anxiety for their child.

In some embodiments, the student profiles 342, 344, 346 and the learning results 352 are made available to the parent terminal 376, supervisor terminal 377, and/or the expert terminal 378. A parent, a supervisor, and/or an expert may then provide inputs to the content generator 360 based on the student profiles 342, 344, and 346, and the learning result(s) 352. In some embodiments, a parent, a supervisor, and/or an expert may also use a corresponding terminal 376, 377, and/or 378 to modify or add additional information to the student profiles 342, 344, 346 or the learning result(s) 352, which in turn cause the content generator 360 to modify the content 362 for the next learning session or class.

As mentioned above, the content 362 may include (but is not limited to) a new source profile template that includes a different set of stimulation tasks related to one or more learning objectives or a different set of teaching actions based on the previous learning result of the student. In some embodiments, the source profile template may also include a graphic theme for the learning environment, an avatar that is to be transformed from a human being teaching entity, voice or accent of the avatar, outfit of the avatar, facial expressions of the avatar, and body actions of the avatar.

For example, in at least one embodiment, the learning platform 300 may be utilized for a math lesson that involves a single teaching entity teaching multiple students through virtual learning. The content generator 360 may identify that a particular student learns better from a teacher of his or her own ethnicity. Similarly, the content generator 360 may identify that another student has a heavy accent and understands the teacher better when the teacher uses the same accent.

Accordingly, the content generator 360 can create multiple, unique avatars that can be used as teaching entities for each of the respective students. For instance, one avatar may match the ethnicity of the particular student, while another avatar speaks with the accent of the other student. The avatar may be overlaid on top of a human teacher such that the avatar mimics the expressions, gestures, and demeanor of the human teacher. Alternatively, the avatar may be wholly virtual such that there is no human teacher. In either case, different students participating in the same class may be presented with unique teaching entities that are visually and auditorily designed for the individual student. Additional, non-limiting, examples of changes that can be made to an avatar include making the avatar a cartoon character, selecting a gender of the avatar, selecting clothing worn by the avatar, selecting the spoken language of the avatar, selecting the speed of speech of the avatar, and various other changes. The particulars of an avatar may be stored within a student profile and/or within a teaching profile.

Further, even though FIG. 3 merely shows one student terminal 372 and one teacher terminal 374 that are sending student data 310 and teacher data 320 to the learning platform 300, the principles described herein are not limited to one student, one teacher, or a specific set of learning objectives. In fact, there may be any number of students or student terminals 372 and any number of teachers or teacher terminals 374 simultaneously sending a corresponding student data or teacher data to the learning platform. For each student and each learning session, a separate student profile is generated by the learning platform. Multiple student profiles for a same student may be organized and stored at the particular student portal as different phased profiles.

In some embodiments, the same student's profiles for different learning sessions with the different set of learning objectives (e.g., learning sessions in math and English) may be stored and used separately. In some embodiments, these student's profiles related to different sets of learning objectives may also be aggregated and analyzed by the learning platform altogether to identify the student's common learning style cross subjects.

In some embodiments, multiple students' profiles for a same learning session may also be aggregated and analyzed together to provide aggregated relationships between certain student facts and teaching facts. For example, the learning platform 300 may identify that most of the students do not like a particular teacher action. Based on such a finding, the content generator 360 may provide a suggestion to the teacher, such that the teacher can refrain from performing the disliked teacher action again in the next learning session.

Finally, for each student and each learning session, a separate student profile is generated. These different students' profiles generated after different learning sessions for different sets of learning objectives may also be aggregated and analyzed to identify universal student-teaching patterns to provide feedback to the learning platform, the teaching entity, and the experts to further improve the learning platform. These pieces of knowledge can also provide insights into the research fields of neuroscience and social emotional learning.

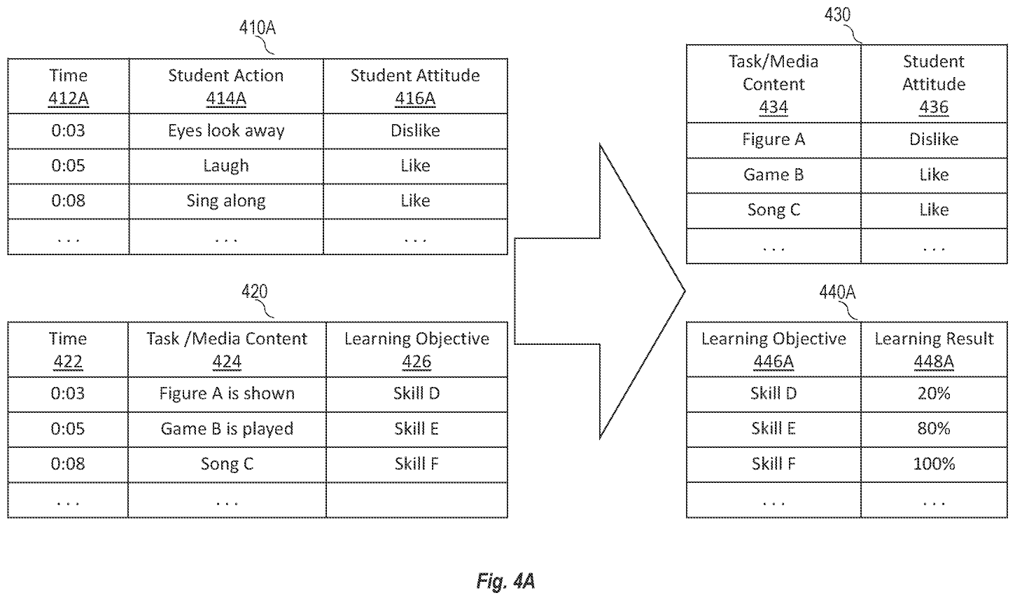

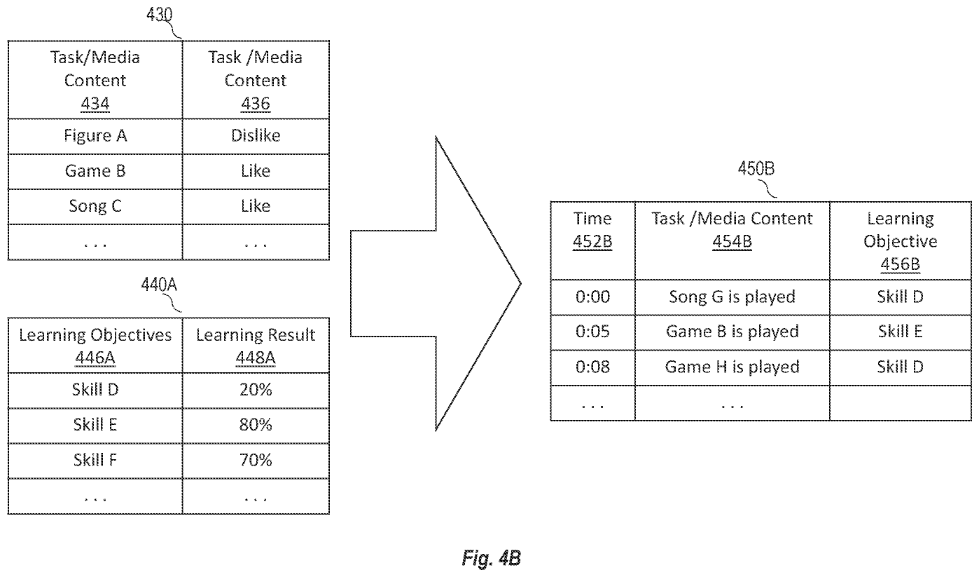

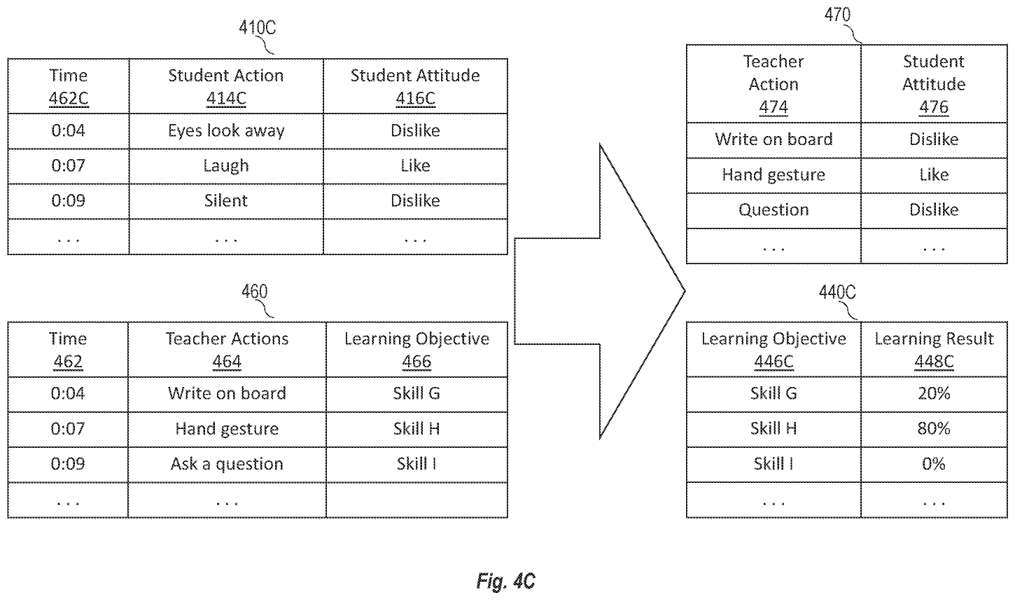

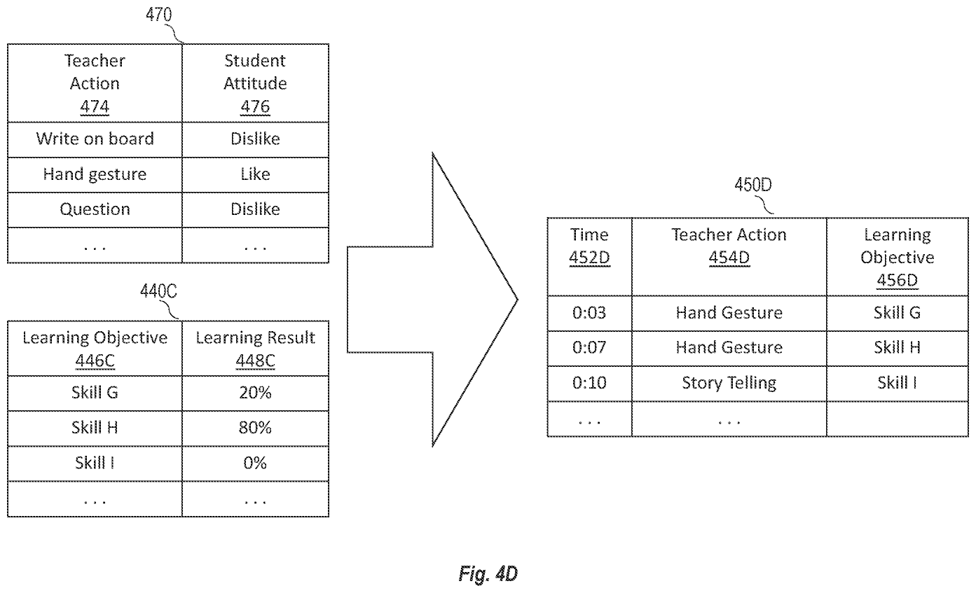

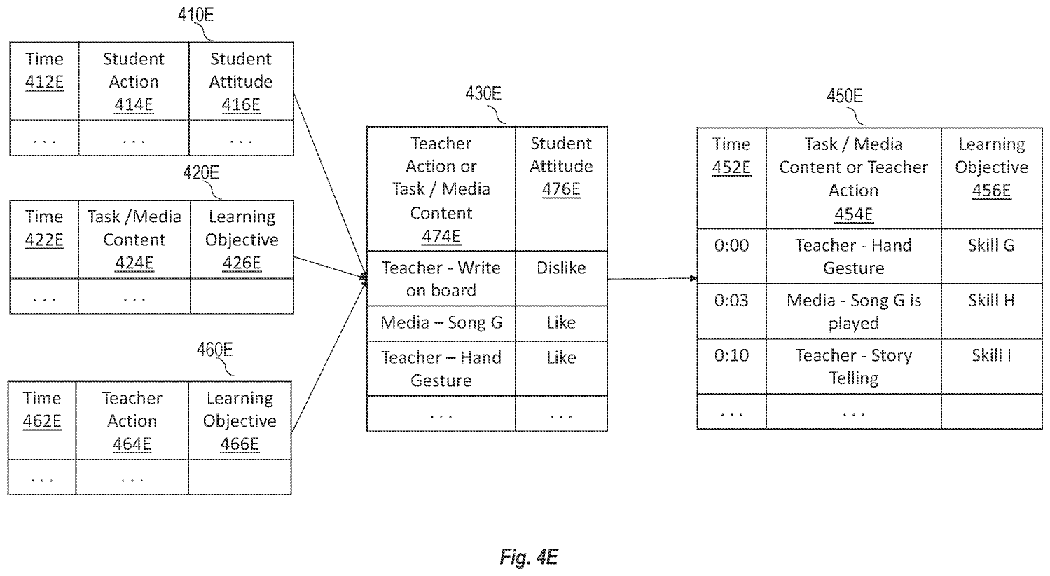

The learning platform 300 may organize and store the classified student facts 314, teaching facts 324, student profiles 342, 344, 346, and learning result(s) 352 in different forms of data structures. FIGS. 4A through 4E illustrate example data structures that may be used to organize or store these various data. Referring to FIG. 4A, table 410A illustrates an example data structure that may be used to store classified student facts. As illustrated in FIG. 4A, table 410A includes a time column 412A, indicating relevant points of time during a learning session. Table 410A also includes a student reaction column 414A and a student attitude column 416A. The student reaction column 414A records the student actions at the relevant points of time of the time column 412A. The student attitude 416A records the student attitudes corresponding to the student actions. For example, the first row of table 410A shows that at 3 minutes point of the learning session, the student's eyes looked away, indicating that he/she probably disliked the content being presented at the time. As another example, the second row of table 410A shows that at five minutes point of the learning session, the student laughed, indicating that he/she liked the content being presented at the time. Similarly, at different points of time, different student actions may be logged, classified, and recorded in table 410A until the learning session is over.

Table 420 illustrates an example data structure that may be used to store classified tasks and media content. As illustrated in FIG. 4A, table 420 includes a time column 422, a task or media content column 424, and a learning objective column 426. Similar to the time column 412 of table 410, the time column 422 records relevant points of time during the learning session. The task/media content column 424 records the stimulation tasks, and/or media content being presented to the student at the relevant points of time of the time column 422. The learning objective column 426 indicates the learning objective of each particular piece of content presented to the student. For example, the first row of table 420 shows that at 3 minutes point of the learning session, Figure A was shown, which is intended to teach skill D. As another example, the second row of the table 420 shows that at 5 minutes point of the learning session, Game B was played, which is intended to teach skill E.

The student facts recorded in 410A and the task and media recorded in table 420 may then be analyzed, mapping the related student facts to task and media content, to generate at least a portion of a student profile. Table 430 illustrates an example data structure of a portion of student profile. As illustrated in FIG. 4A, table 430 includes a task/media content column 434 and a student attitude column 436. For example, the first row of table 430 shows that the student dislikes Figure A, because at 3 minutes point of the learning session, when Figure A was shown, the student's eyes looked away, indicating a “dislike” attitude. Similarly, the second and third rows of table 430 show that the student likes Game B and Song C, because at the times when Game B and Song C were played, the student's action indicates an “like” attitude. Note, it is not necessary that each student fact must be mapped to a task/media content fact. There may be some student facts that cannot be mapped to any task or media content facts, and there may also be some task or media content facts that did not trigger any student fact. As long as there are a sufficient number of mapped pairs of student fact(s) and task or media content fact(s), the learning platform can provide helpful results to users.

The student facts recorded in 410A and the task and media content recorded in table 420 may also be used to identify the learning result of the student. In some embodiments, the learning session is a domain-specific knowledge-based learning session, which teaches one or more pieces of domain-specific knowledge to students. The one or more objectives for the domain-specific knowledge-based learning session is to have the students memorizes the one or more pieces of domain-specific knowledge consciously with mental effort. At least some of the stimulation tasks may be designed to trigger a student interaction, which may, in turn, be used to determine whether a student has mastered a taught domain-specific knowledge. For example, at 8 minutes point of the learning session, the student sang along with the media content presented, which indicates that the student has mastered 100% of Skill F. In some cases, for a same domain-specific knowledge, there may be multiple stimulation tasks used to test whether the student has mastered it. Some of the student interactions may indicate that the student has mastered it, and some of the student interactions may indicate that the student has not mastered it. The multiple student interactions may then be aggregated to generate a score (e.g., a percentage point), indicating how well the student has mastered the knowledge.

Table 440A illustrates an example data structure for recording the learning result of the student. As illustrated, table 440A includes a learning objective column 446A and a learning result column 448A. The learning objective column 446A lists all the learning objectives of the learning session, and the learning result column 448A records a percentage point score of the student for each learning objective. For example, the first row of table 440A indicates that the student only mastered about 20% of Skill D, the second row of table 440A indicates that the student has mastered 80% of Skill E, etc.

Based on the student profile 420 and the learning result 440, the learning platform may then generate contents (e.g., a template) for a next learning session. When there are one or more previously generated student profiles, the contents for the next learning session may be generated based on multiple student profiles and the learning result 440A.

FIG. 4B illustrates an example data structure of a portion of a learning session template 450B generated based on the student profile 430 and the learning result 440A. As illustrated in FIG. 4B, table 450B includes a time column 452B, a task/media content column 454B, and a learning objective column 456B. For example, the first row of table 450B shows that at the beginning of the learning session, Song G is played, and the third row of table 450B shows that at 8 minutes time of the learning session, Game H is played. Both Song G and Game H are intended to teach Skill D. This may be caused by the student fact indicating that the student disliked Figure A when Skill D was taught, and the previous learning result shows that the student only mastered 20% of Skill D. As another example, the second row of table 450B shows that at the 5 minutes time point, Game B is played, intended to teach Skill E. This may be caused by the student fact indicating that the student liked Game B, and the previous learning result shows that the student mastered 80% of Skill E. Thus, there is still a 20% room for improving Skill E. Further, since the previous learning result shows that the student has completely mastered Skill E, no more learning materials for Skill E needs to be presented in the next learning session.

Similarly, the student actions may also be mapped to teacher actions. FIGS. 4C and 4D illustrate example data structures 410C and 460 that are used to store student facts and teacher facts. The data structure 410C is similar to the data structure 410A, configured to store student facts. In some embodiments, the student facts 410A (corresponding to task or media content 420) and the student facts 410C (corresponding to teacher facts 460) may be stored all together in a same data structure. In such embodiments, some of the student facts are mapped to the task or media content, and some of the student facts are mapped to the teacher facts 460. Alternatively, in some embodiments, the two sets of student facts 410A or 410C may be stored separately.

As illustrated in FIG. 4C, table 410C includes a time column 412C, indicating relevant points of time during a learning session. Table 410C also includes a student reaction column 414C and a student attitude column 416C. The student reaction column 414C records the student actions at the relevant points of time of the time column 412C. The student attitude 416C records the student attitudes corresponding to the student actions. For example, the first row of table 410C shows that at 4 minutes point of the learning session, the student's eyes looked away, indicating he/she probably disliked the teacher action (e.g., writing on board) performed at the time. As another example, the second row of table 410C shows that at seven minutes point of the learning session, the student laughed, indicating that he/she liked the teacher action (e.g., hand gesture) performed at the time. Similarly, at different points of time, different student actions may be logged, classified, and recorded in table 410C until the learning session is over.

Table 460 illustrates an example data structure that may be used to store teacher actions. As illustrated in FIG. 4C, table 460 includes a time column 462, a teacher action column 464, and a learning objective column 466. Similar to the time column 412C of table 410C, the time column 462 records relevant points of time during the learning session. The teacher action column 464 records the classified teacher actions or facts being performed in front of the student at the relevant points of time in the time column 462. The learning objective column 466 indicates the learning objective of each particular teacher actions. For example, the first row of table 460 shows that at 4 minutes point of the learning session, the teacher wrote on a board, which is intended to teach skill G. As another example, the second row of the table 460 shows that at 7 minutes point of the learning session, the teacher used a hand gesture, which is intended to teach skill H.

The student facts recorded in 410C and the teacher facts recorded in 460 may then be analyzed, mapping the related student facts to teacher facts, to generate at least a portion of a student profile 470. Table 470 illustrates an example data structure of a portion of student profile generated by mapping student data 410C to teacher data 460. As illustrated in FIG. 4C, table 470 includes a teacher action column 474 and a student attitude column 476. For example, the first row of table 470 shows that the student dislikes the teacher action of writing on board, because at 4 minutes point of the learning session, when the teacher wrote on the board, the student's eyes looked away, indicating a “dislike” attitude. Similarly, the second and third rows of table 470 show that the student likes the hand gesture and dislikes the question being asked, because at the times when the hand gesture was performed, the student's action indicates a “like” attitude; and when the question was asked, the student's action indicates a “dislike” attitude. Note, it is not necessary that each student fact must be mapped to a teacher fact. There may be some student facts that cannot be mapped to any teacher facts, and there may also be some teacher facts that did not trigger any student fact. As long as there are a sufficient number of mapped pairs of student fact(s) and teacher fact(s), the learning platform can provide helpful results to users.

Similar to FIG. 4A, in some embodiments, the mapped student facts and teacher facts may also be used to determine a result of the learning session. The result of the learning session may be stored in the example data structure 440C. For example, when the teacher asked the question at the 9 minute point, the student was silent, indicating that the student probably did not master the Skill I that was taught during the learning session. Thus, based on the student reaction (i.e., silent) to the teacher action (the question), the learning platform may determine that the student has not mastered Skill I. Again, as illustrated in FIG. 4D, similar to FIG. 4B, based on the portion of student profile 470 and the learning result 440C, the learning platform may then be used to generate contents 450D for a next learning session.

Notably, the learning result stored in 440A and the learning result stored in 440C may be aggregated and integrated into a single data structure. Similarly, the portion of the student profile 430 (associated with the task/media content) and the portion of student profile 470 (associated with the teacher action) may also be aggregated and integrated into a single data structure. Finally, the generated contents or template 450B and 450D for a next learning session may also be aggregated and integrated into a single data structure.

FIG. 4E illustrates an example process of using classified student data 410E, task/media content 420E, and teacher fact 460E to generate a single data structure 450E that includes contents or template for the next learning session. In some embodiments, the classifying of the teaching facts (including the task/media contents 420E and the teacher actions 460E) and the classifying of the student facts 410E are performed in substantially real time. The student profile 430E is constantly updated when a new teaching fact and a new student fact are mapped to each other. In the case that a virtual teaching entity is being used, the learning platform 100 can integrate changes into a lesson profile in real time. For example, an avatar may be adjusted to speak more loudly or to incorporate more object lessons based upon student's real-time responses. In at least one embodiment, when a human teacher is being used, when the learning session is over, the learning platform uses final student profile 430E containing the mapped teaching facts (including teacher actions 420E and task/media contents 460E) and the student facts 410E to generate contents 450E for a next learning session. The human teacher can then review the information and identify changes and improvements that he or she can make.

FIGS. 4A through 4E are merely schematic examples of data structures that may be used to store data generated during and after a learning session. Different or additional data may be stored in different or additional data structures. For example, the learning platform may also determine whether the student prefers a human teacher or an avatar, and/or whether the student learns better with interactions with a teaching entity or without any teaching entity. As another example, the learning platform may also determine whether the student prefers a particular graphic theme (e.g., flowers, princesses, airplanes, animals, etc.). These student facts can also be mapped to these teaching facts when generating a template for a next learning session.

The following discussion now refers to a method and method acts that may be performed. Although the method acts may be discussed in a certain order or illustrated in a flow chart as occurring in a particular order, no particular ordering is required unless specifically stated, or required because an act is dependent on another act being completed prior to the act being performed.

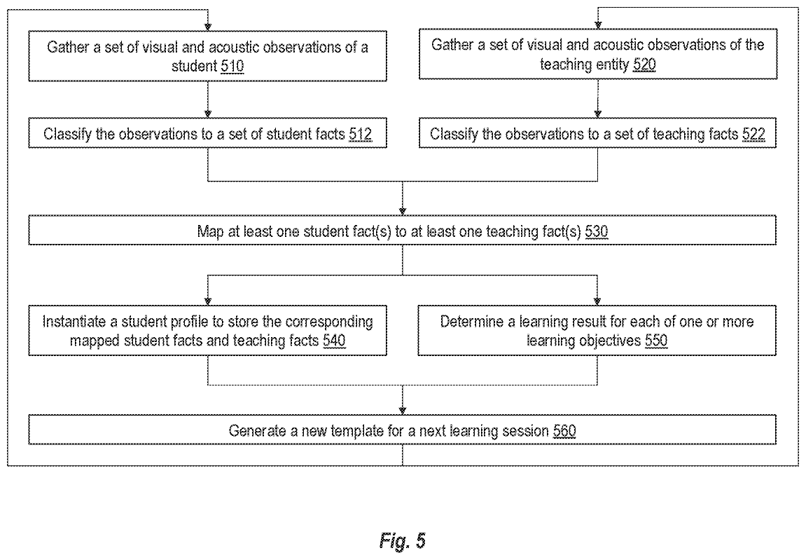

FIG. 5 illustrates a flowchart of an example method 500 for generating a personalized learning experience via a digital learning platform. The digital learning platform may correspond to the digital learning platform 112 of FIG. 1 and/or 300 of FIG. 3. The method 500 includes gathering a set of visual and acoustic observations of a student (510) and classifying the set of visual and acoustic observations of the student into a set of student facts (512). The method 500 also includes gathering a set of visual and acoustic observations of a teaching entity (520) and classifying the set of visual and acoustic observations of the teaching entity into a set of teaching facts (522). For example, the student facts may include (but not limited to) student attitudes, such as “like”, “dislike”, “mindful”, “absentminded”, etc. The teaching facts may include (but not limited to) various actions performed by the teaching entity (e.g., voice volumes, hand gestures, facial expressions, body movements, etc.) and/or various stimulus tasks presented to the student (e.g., music pieces, colors, figures, games, songs, etc.).

At least one student fact among the set of student facts is then mapped to at least one teaching fact among the set of teaching facts (530). The mapped at least one student fact(s) and at least one teaching fact(s) are then stored in an instantiated student profile (540). In some embodiments, the mapped at least one student fact(s) and the mapped at least one teaching fact(s) are further analyzed to determine the learning result(s) of the student through the learning session (550). For example, the learning session may have one or more predetermined learning objectives, each of which may correspond to a particular skill. For each of the one or more learning objectives, a percentage point score may be generated, indicating how well the student has mastered a particular skill of the corresponding learning objective. Finally, the student profile and the learning result(s) are then used to generate a template for a next learning session (560).

When the student participates in the next learning session, this process may repeat again. For example, a second student profile and a second learning result are generated for the next learning session. Based on the first student profile, the second student profile, and the current learning result, a template for a third learning session may be generated.

As such, for a same student, there may be multiple student profiles generated for learning sessions with a same set of learning objectives. In addition, there may also be multiple student profiles generated for learning sessions with a different set of learning objectives. These student profiles of the same student generated for different learning sessions with same or different sets of learning objectives (e.g., math learning sessions and English learning sessions) may also be aggregated and analyzed by the digital learning platform to generate a template for a next learning session.

Further, different students may have participated in a same learning session, and each of the different students has a separate learning profile. These different students' profiles for the same learning session may also be aggregated and analyzed to identify student-teaching patterns to provide feedback to the teaching entity.

Finally, for each student and each learning session, a separate student profile is generated. These different students' profiles generated after different learning sessions for different sets of learning objectives may also be aggregated and analyzed to identify student-teaching patterns to provide feedback to the teaching entity and the experts to further improve the learning platform. These pieces of knowledge can also provide insights into the research fields of neuroscience and social emotional learning.

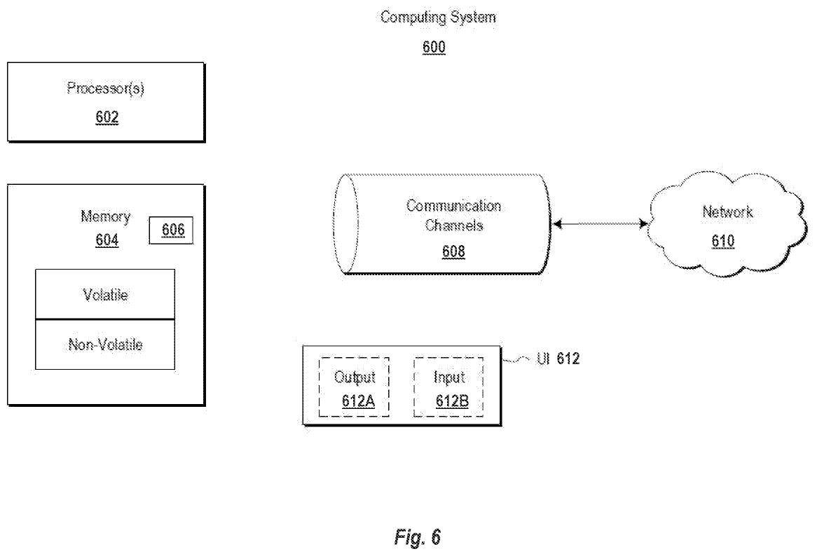

Finally, because the principles described herein may be performed in the context of a computing system (for example, the server 110 and each of the terminals 120A, 120B, 130A, 130B, 140A, 140B, 150A, 150B may include one or more computing systems) some introductory discussion of a computing system will be described with respect to FIG. 6.

Computing systems are now increasingly taking a wide variety of forms. Computing systems may, for example, be handheld devices, appliances, laptop computers, desktop computers, mainframes, distributed computing systems, data centers, or even devices that have not conventionally been considered a computing system, such as wearables (e.g., glasses, HMDs). In this description and in the claims, the term “computing system” is defined broadly as including any device or system (or a combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 6, in its most basic configuration, a computing system 600 typically includes at least one hardware processing unit 602 and memory 604. The processing unit 602 may include a general-purpose processor and may also include a field-programmable gate array (FPGA), an application-specific integrated circuit (ASIC), or any other specialized circuit. The memory 604 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 600 also has thereon multiple structures often referred to as an “executable component”. For instance, memory 604 of the computing system 600 is illustrated as including executable component 606. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such a structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures, such as hardcoded or hard-wired logic gates, that are implemented exclusively or near-exclusively in hardware, such as within a field-programmable gate array (FPGA), an application-specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent”, “manager”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied in one or more computer-readable media that form a computer program product. An example of such an operation involves the manipulation of data. If such acts are implemented exclusively or near-exclusively in hardware, such as within an FPGA or an ASIC, the computer-executable instructions may be hardcoded or hard-wired logic gates. The computer-executable instructions (and the manipulated data) may be stored in the memory 604 of the computing system 600. Computing system 600 may also contain communication channels 608 that allow the computing system 600 to communicate with other computing systems over, for example, network 610.

While not all computing systems require a user interface, in some embodiments, the computing system 600 includes a user interface system 612 for use in interfacing with a user. The user interface system 612 may include output mechanisms 612A as well as input mechanisms 612B. The principles described herein are not limited to the precise output mechanisms 612A or input mechanisms 612B as such will depend on the nature of the device. However, output mechanisms 612A might include, for instance, speakers, displays, tactile output, holograms and so forth. Examples of input mechanisms 612B might include, for instance, microphones, touchscreens, holograms, cameras, keyboards, mouse or other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general-purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM, or other optical disk storage, magnetic disk storage, or other magnetic storage devices, or any other physical and tangible storage medium which can be used to store desired program code means in the form of computer-executable instructions or data structures and which can be accessed by a general-purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmission media can include a network and/or data links which can be used to carry desired program code means in the form of computer-executable instructions or data structures and which can be accessed by a general-purpose or special-purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general-purpose computing system, special purpose computing system, or special purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, data centers, wearables (such as glasses) and the like. The invention may also be practiced in distributed system environments where local and remote computing system, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

The remaining figures may discuss various computing system which may correspond to the computing system 600 previously described. The computing systems of the remaining figures include various components or functional blocks that may implement the various embodiments disclosed herein as will be explained. The various components or functional blocks may be implemented on a local computing system or may be implemented on a distributed computing system that includes elements resident in the cloud or that implement aspect of cloud computing. The various components or functional blocks may be implemented as software, hardware, or a combination of software and hardware. The computing systems of the remaining figures may include more or less than the components illustrated in the figures and some of the components may be combined as circumstances warrant. Although not necessarily illustrated, the various components of the computing systems may access and/or utilize a processor and memory, such as processor 602 and memory 604, as needed to perform their various functions.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computing system for dynamically providing personalized learning experience to students via a digital learning platform, comprising:
one or more processors; and
one or more computer-readable media having thereon computer-executable instructions that are structured such that, when executed by the one or more processors, cause the computing system to perform the following:
during a learning session, in which a teaching entity teaches a lesson having one or more learning objectives,
gather a first set of visual and acoustic observations of a student who is participating in the learning session;
gather a first set of visual and acoustic observations of the teaching entity who is teaching in the learning session;
based on the first set of visual and acoustic observations of the student, classify a first set of one or more student facts that are associated with the student;
based on the first set of visual and acoustic observations of the teaching entity, classify a first set of one or more teaching facts that are associated with the teaching entity or teaching materials;
automatically map at least one student fact among the first set of one or more student facts to at least one teaching fact among the first set of teaching facts;
instantiate a first student profile to store the mapped at least one student fact and the at least one teaching fact;
determine a learning result for each of the one or more learning objectives based on the first student profile; and
based upon the first student profile and the learning result for each of the one or more learning objectives, automatically generate a template for a next learning session.

2. The computing system of claim 1, wherein the teaching entity is a human being.

3. The computing system of claim 1, wherein the teaching entity is an avatar.

4. The computing system of claim 1, wherein the classifying of the first set of one or more student facts or the classifying the first set of one or more teaching facts comprises at least one of (1) digital image-based recognition or (2) natural language processing.

5. The computing system of claim 1, wherein the classifying of the first set of one or more student facts that are associated with the student includes:
detecting a student interaction to a teaching fact in substantially real time; and
classifying the student interaction into a student fact.

6. The computing system of claim 1, wherein the learning session is domain-specific knowledge-based learning session that teaches one or more pieces of domain-specific knowledge to at least one student, and the one or more learning objectives for the domain-specific knowledge-based learning session is to have the at least one student memorize the one or more pieces of domain-specific knowledge consciously with mental effort, and
at least one student fact among the first set of one or more student facts indicates whether the student has mastered at least one of the one or more pieces of domain-specific knowledge.

7. The computing system of claim 1, wherein the mapping of at least one student fact among the first set of one or more student facts to at least one teaching fact among the first set of teaching facts comprises using logistic regression to automatically map the at least one student fact to the at least one teaching fact.

8. The computing system of claim 1, the template includes at least one of (1) one or more teaching actions to be performed by a teaching entity, (2) one or more stimulation tasks, each of which comprises at least one of a music piece, a color, a figure, a game, or a song, (3) an avatar converting a real teaching entity into a virtual teaching entity, (4) a particular clothing outfit of the virtual teaching entity, (5) a particular voice of the virtual teaching entity, and/or (6) an accent of the virtual teaching entity.

9. The computing system of claim 1, the computing system further caused to:
present the first student profile to a user; and
receive a user input from the user, manually mapping at least one student fact among the first set of one or more student facts to at least one teaching fact among the first set of teaching facts; and
wherein the generating of the template is based on the automatically mapped at least one student fact and teaching fact and the manually mapped at least one student fact and teaching fact.

10. The computing system of claim 1, the computing system further caused to perform the following:
during the next learning session, in which a teaching entity teaches a second lesson based on the generated template:
capture a second set of visual and acoustic observations of the student who is participating in the learning session;
capture a second set of visual and acoustic observations of the teaching entity who is teaching in the learning session;
based on the second set of visual and acoustic observations of the student, classify a second set of one or more student facts that are associated with the student;
based on the second set of visual and acoustic observations of the teaching entity, classify a second set of one or more teaching facts that are associated with the teaching entity or teaching materials;
map at least one student facts of the second set of one or more student facts to at least one teaching facts of the second set of teaching facts;
instantiate a second student profile to store the mapped at least one student facts and the at least one teaching facts;
determining a second learning result for each of the one or more learning objectives based on the second student profile; and
based upon the first student profile, the second student profile, and the second learning result, generate a new template for a next learning session.

11. The computing system of claim 1, wherein each learning result includes a score indicating how well the student has mastered one of the one or more learning objectives.

12. The computing system of claim 1, wherein the first set of one or more student facts include at least one of the following: (1) a fact related to an emotion of the student, (2) a fact related to mindfulness of the student, (3) a fact related to whether the student is interested in a visualization in a virtual environment, or (4) a fact related to whether the student is interested in a sound in the virtual environment.

13. The computing system of claim 1, wherein the first set of one or more teaching facts include at least one of the following: (1) a fact related to a voice of the teaching entity, (2) a fact related to an accent of the teaching entity, (3) a fact related to a facial expression of the teaching entity, (4) a fact related to a gesture of the teaching entity, or (5) a fact related to a clothing outfit of the teaching entity.

14. The computing system of claim 1, wherein the classifying of the first set of the one or more student facts comprises:
tracking a gaze of the student;
identifying one or more objects that are included in the gaze of the student; and
determining whether the student is interested in the one or more objects.

15. The computing system of claim 14, wherein the determining whether the student is interested in the one or more objects comprises:
identifying an amount of time that the gaze of the student includes a particular object; and
when the amount of time is greater than a threshold, determining that the student is interested in the particular object.

16. The computing system of claim 14, wherein:
at least one of the one or more objects is configured to move,
the identifying one or more objects that are included in the gaze of the student includes identifying the at least one object when the at least one of the one or more object is moving; and
determining whether the student is interested in a particular movement of the at least one object.

17. The computing system of claim 14, wherein:
at least one of the one or more objects is configured to make a sound;
the identifying one or more objects that are included in the gaze of the student includes identifying the at least one object when the at least one objects is making a sound; and
determining whether the student is interested in a particular sound of the at least one objects.

18. The computing system of claim 1, wherein the student is a first student, and during the learning session, the computing system further configured to:
captures a second set of visual and acoustic observations of a second student who is participating in the learning session;
based on the second set of visual and acoustic observations of the second student, classify a second set of one or more student facts that are associated with the second student;
map at least one student fact among the second set of one or more student facts to at least one teaching fact among the first set of one or more teaching facts;
instantiate a second student profile to store the mapped at least one student fact of the second student and teaching facts;
determine a second learning result for each of the one or more learning objectives based on the first student profile; and
based upon the second student profile and the second learning result, generate a second template for a next learning session for the second student.

19. A method implemented at a computing system for dynamically providing personalized learning experiences to students via a digital learning platform, the method comprising:
during a learning session, in which a teaching entity teaches a lesson having one or more learning objectives,
gathering a first set of visual and acoustic observations of a student who is participating in the learning session;
gathering a first set of visual and acoustic observations of the teaching entity who is teaching in the learning session;
based on the first set of visual and acoustic observations of the student, classifying a first set of one or more student facts that are associated with the student;
based on the first set of visual and acoustic observations of the teaching entity, classifying a first set of one or more teaching facts that are associated with the teaching entity or teaching materials;
automatically mapping at least one student fact among the first set of one or more student facts to at least one teaching fact among the first set of teaching facts;
instantiating a first student profile to store the mapped at least one student fact and the at least one teaching fact;
determining a learning result for each of the one or more learning objectives based on the first student profile; and
based upon the first student profile and the learning result for each of the one or more learning objectives, automatically generating a template for a next learning session.

20. A computer program product comprising one or more hardware storage devices having stored thereon computer-executable instructions that are structured such that, when executed by one or more processors of a computing system, the computer-executable instructions cause the computer system to perform the following:
during a learning session, in which a teaching entity teaches a lesson having one or more learning objectives,
gather a first set of visual and acoustic observations of a student who is participating in the learning session;
gather a first set of visual and acoustic observations of the teaching entity who is teaching in the learning session;
based on the first set of visual and acoustic observations of the student, classify a first set of one or more student facts that are associated with the student;
based on the first set of visual and acoustic observations of the teaching entity, classify a first set of one or more teaching facts that are associated with the teaching entity or teaching materials;
automatically map at least one student fact among the first set of one or more student facts to at least one teaching fact among the first set of teaching facts;
instantiate a first student profile to store the mapped at least one student fact and the at least one teaching fact;
determine a learning result for each of the one or more learning objectives based on the first student profile; and
based upon the first student profile and the learning result for each of the one or more learning objectives, automatically generate a template for a next learning session.
